(19) United States
(12) Patent Application Publication
(10) Pub. No.: US 2008/0053551 A1
(43) Pub. Date: Mar. 6, 2008

(54) Multilayer hose construction

(75) Inventors: Richard Wayne Hatchett, Huntingdon, TN (US); John Mobley, Lexington, TN (US); Jerry Shifman, Wildersville, TN (US); Jeremy W. Duke, Lexington, TN (US)

Correspondence Address: DAYCO PRODUCTS, LLC, 1 PRESTIGE PLACE, MIAMISBURG, OH, 45342, US

(73) Assignee: Dayco Products,LLC

(21) Appl. No.: 11/711,700

(22) Filed: Feb. 27, 2007

Related U.S. Application Data
(63) Continuation-in-part of application No. 11/513,384, filed on Aug. 30, 2006.

(51) Int. Cl. F16L 11/00

(52) U.S. Cl. 138/125; 138/137; 428/36.91

(57) ABSTRACT

A fuel feed hose and a fuel vapor line hose having reduced fuel permeation comprises a conductive FKM inner tubular structure and a chlorinated polyethylene backing layer. The hose optionally contains an adhesive layer between the conductive FKM inner layer and the chlorinated polyethylene backing layer. Furthermore, the hose optionally contains a reinforcement member and a cover over the reinforcement member. A method of forming such tubular structures is also included.

This application is a continuation-in-part of U.S. patent application Ser. No. 11/513,384, filed Aug. 30, 2006.

### BACKGROUND OF THE INVENTION

The present invention relates to the field of multilayer hoses, and particularly to the field of flexible polymeric hoses for use in fuel feed and vapor lines

Flexible polymeric hoses are generally used in a variety of uses such as automobile fuel feed hoses, fuel vent hoses, torque converter hoses, power steering hoses, air conditioner hoses, brake fluid hoses, industrial hydraulic hoses and compressed gas hoses, refrigerator hoses, garden hoses, propane gas hoses, etc. Various types of tubing construction have been employed to meet the needs of the various applications of hoses. For example, multilayer tubular structures are commonly used in the automotive industry as fuel feed and vapor lines. Choosing the right combination of materials used in the construction of such hoses is becoming more difficult due to environmental regulations, which severely limit the amount of fuel vapor that can permeate from the fuel system of a motor vehicle. Currently, fuel feed and vent lines are multilayer tubular structures constructed of a fluoropolymer (FKM) inner layer, a nitrile or epichlorohydrin (ECO) backing layer, a reinforcement layer, and a chlorinated polyethylene (CPE), chlorosulfonated polyethylene (CSM) or epichlorohydrin cover layer.

The overall cost and effectiveness of such hoses has proven to be somewhat disappointing. Therefore, there is a need for fuel feed and vapor line hose which is more economical to produce and which exhibits improved properties.

### SUMMARY OF THE INVENTION

According to the present invention there is provided an improved multilayer fuel hose having a chlorinated polyethylene backing layer which is less costly to manufacture than prior multilayer fuel hoses. Furthermore, the multilayer hose of the present invention employing a chlorinated polyethylene backing layer exhibits superior fuel resistance compared to either the nitrile or epichlorohydrin materials currently used as a backing layer. In addition to reduced fuel resistance, the hose offers improved heat resistance and ozone resistance as well as sufficient strength and durability over long periods of service.

Generally, the multilayer hose of the present invention comprises an inner fluoropolymer barrier layer, a reinforcement layer, a chlorinated polyethylene backing layer, and a cover layer.

Since it is well known in the industry that hoses used to transport fuels contain a conductive agent or otherwise exhibit conductive characteristics in order to dissipate any electrical buildup, which may occur during the flow of fuel through the hose, the hose of the present application may contain such conductive agent.

In those instances where the fluoropolymer is adjacent the chlorinated polyethylene layer, an adhesive that is effective to adhere a fluoropolymer to a chlorinated polyethylene is preferably used to adhere the fluoropolymer layer to the CPE layer.

Typically, the hoses of the present invention are useful as an automobile fuel vent hose, fuel filler hose, vapor lines and fuel feed lines.

### BRIEF DESCRIPTION OF THE DRAWINGS

FIG. 1 is a perspective view illustrating a first embodiment of the invention;

FIG. 2 is a perspective view illustrating a second embodiment of the invention;

FIG. 3 is a perspective view illustrating a third embodiment of the invention;

FIG. 4 is a perspective view illustrating a fourth embodiment of the invention;

### DETAILED DESCRIPTION OF THE INVENTION

In a first embodiment, the hose of the present invention comprise: a conductive FKM fluoropolymer inner layer and a chlorinated polyethylene (CPE) backing layer on the conductive FKM fluoropolymer inner layer.

In a second embodiment, the hose of the present invention comprises: a conductive FKM fluoropolymer inner layer, an adhesive layer on the conductive FKM fluoropolymer inner layer, and a chlorinated polyethylene backing layer on the adhesive layer.

In a third embodiment, the hose of the present invention comprises a conductive FKM fluoropolymer inner layer, an adhesive layer, a chlorinated polyethylene (CPE) backing layer, a reinforcement layer, and a cover layer.

In a fourth embodiment, the hose of the present invention comprises a conductive FKM fluoropolymer inner layer, a reinforcement layer and a chlorinated polyethylene (CPE) backing layer.

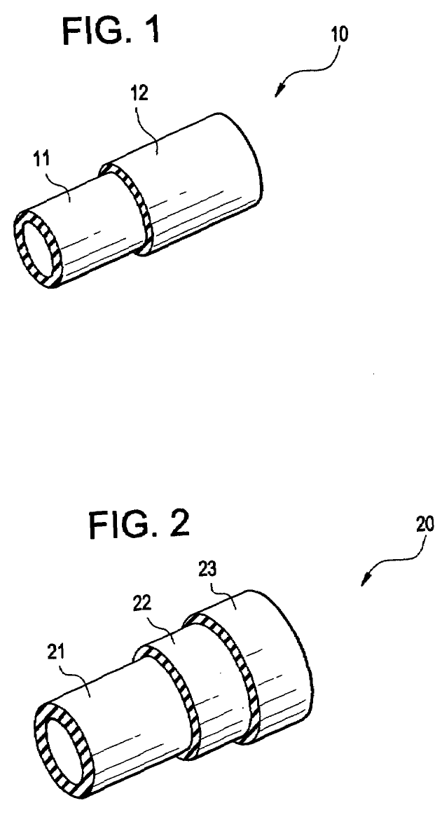

With respect to the drawings, FIG. 1 is a tubular structure in accordance with a first embodiment of the invention where a tubular structure 10 is made from a fluoropolymer inner layer 11 and a chlorinated polyethylene backing layer 12 on the fluoropolymer inner layer.

FIG. 2 is a tubular structure in accordance with a second embodiment of the invention where a tubular structure 20 is made from a fluoropolymer inner layer 21, an adhesive layer 23 surrounding the outer surface of the fluoropolymer inner layer 21, and a chlorinated polyethylene backing layer 24, and forming the outside layer of the tubular structure 20.

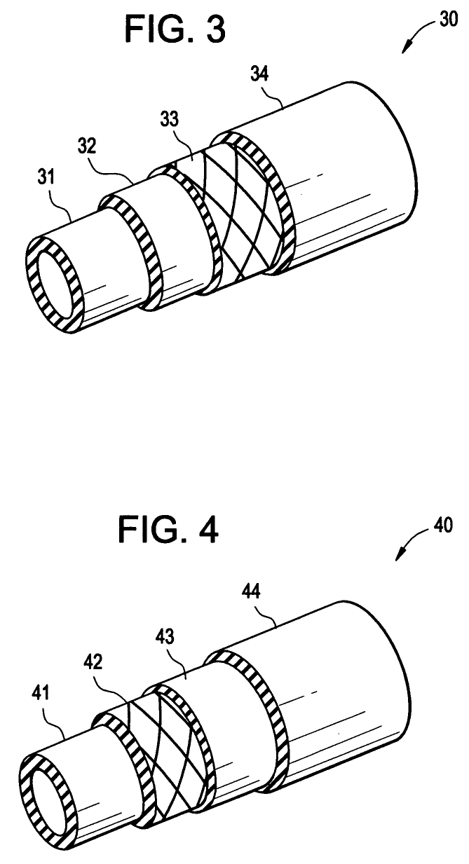

FIG. 3 is a tubular structure in accordance with a third embodiment of the invention where a tubular structure 30 is made from a fluoropolymer inner layer 31, a chlorinated polyethylene backing layer 32 surrounding the fluoropolymer inner layer 31, a reinforcement layer 33 surrounding the chlorinated polyethylene backing layer 32, and a cover layer 34 surrounding the reinforcement layer 33, and forming a cover layer 34 of the tubular structure 30.

FIG. 4 is a tubular structure in accordance with a fourth embodiment of the invention where a tubular structure 40 is made from a fluoropolymer inner layer 41, a reinforcement layer 42 surrounding the fluoropolymer inner layer 41, a chlorinated polyethylene backing layer 43 surrounding the reinforcement layer 42, and a cover layer 44 surrounding the chlorinated polyethylene backing layer 43, and forming a cover layer 44 of the tubular structure 40.

FIG. 5 is a tubular structure in accordance with a fifth embodiment of the invention where a tubular structure 50 is made from a conductive FKM fluoropolymer inner layer 51, a fluoropolymer barrier layer 52 surrounding the conductive FKM inner layer 51, an adhesive layer 53 surrounding the fluoropolymer barrier layer 52, and a chlorinated polyethylene layer 54 surrounding the adhesive layer 53.

FIG. 6 is a tubular structure in accordance with a sixth embodiment of the invention where a tubular structure 60 is made from a conductive inner FKM inner layer 61, a fluoropolymer barrier layer 62 surrounding the FKM inner layer 61, an adhesive layer 63 surrounding the fluoropolymer barrier layer 62, a chlorinated polyethylene layer 64 surrounding the adhesive layer 63, a reinforcement member 65 surrounding the chlorinated polyethylene layer 65 and a cover 66 surrounding the reinforcement member layer 65

Typically, the backing layer of prior tubular structures is a nitrile such as acrylonitrile-butadiene polymer, or an epichlorohydrin (ECO) material. It has been found that, in the manufacture of a fuel feed or vapor line hose, chlorinated polyethylene provides an improved and more cost efficient alternative to the nitrile or epichlorohydrin as the backing layer.

The inner layer of the tubular structure is a fluoropolymer that prevents or reduces the permeation of fuel, chemical and vapor through the barrier layer. Typically, the inner layer is an FKM fluoroelastomer composition such as fluoroelastomeric tetrafluoroethylene-hexafluoropropylene-vinylidene terpolymers. Such FKM fluoroelastomers useful in the present invention are the FLUOREL fluoroelastomers available from Dyneon.

The reinforcement materials useful in the present invention are materials, which afford physical strength to the finished hose. Typically, the reinforcement member is a plurality of synthetic or natural fibers selected from the group consisting of glass fibers, cotton fibers, polyamide fibers, polyester fibers, rayon fibers and the like. Preferably, the reinforcement material is an aromatic polyamide such as Kevlar or Nomex, both of which are manufactured by DuPont. The reinforcing materials may be knitted, braided or spiraled to form the reinforcement member. In a preferred aspect of the invention, the reinforcing material is spiraled. While the reinforcement member may be a preferred component of the present hose structure, it is not critical in every application. Therefore, the reinforcement member may or may not be used in the manufacture of certain hoses depending on the requirements of the manufacturer.

Typically, the inner layer of the tubular structure contains a conductive material such as metal or carbon. Preferably, the conductive material is carbon in the form of carbon black, but may be any conductive agent or combination of conducting agents commonly recognized in the industry to provide conductivity to a rubber or plastic material. Examples of such conductive agents include elemental carbon in the form of carbon black and carbon fibrils, metals such as copper, silver, gold, nickel, and alloys or mixtures of such metals. The use of such conductive agents is known in the art to dissipate static electricity in the transportation of a fluid through the tubular structure. Non-conducting elastomeric polymer materials may be employed as the inner layer in applications where dissipation of static electricity is not required.

The outer cover is a protective layer of any of the commercially recognized materials for such use such as elastomers, thermoplastic polymers, thermosetting polymers, and the like. Typically, the protective layer is a synthetic elastomer having good heat resistance, oil resistance, weather resistance and flame resistance. Preferably, the outer cover is a synthetic elastomer selected from the group consisting of styrene-butadiene rubber (SBR); butadiene-nitrile rubber such as butadiene- acrylonitrile rubber, chlorinated polyethylene, chlorosulfonated polyethylene, vinylethylene-acrylic rubber, acrylic rubber, epichlorohydrin, e.g., Hydrin 200, a copolymer of epichlorohydrin and ethylene oxide available from DuPont, polychloroprene rubber (CR), polyvinyl chloride, ethylene-propylene rubber (EP), ethylene-propylene-diene terpolymer (EPDM), ultra high molecular weight polyethylene (UHMWPE), high density polyethylene (HDPE), and blends thereof. Preferably, the cover layer is chlorinated polyethylene.

In accordance with the present invention, an adhesive material is typically employed between the fluoropolymer barrier layer and the chlorinated polyethylene barrier layer or outer cover layer of the hose in order to prevent or reduce the likelihood of the two layers separating during use. Typically, the adhesive material is a polyamine and, most preferably, the adhesive is polyallylamine.

Other additives such as antioxidants, fillers, plasticizers, metal oxides/hydroxides, processing aids, crosslinking agents, co-agents etc. may be employed in amounts and methods known in the art to provide their desired effects.

The tubular structures of the present invention are formed by known methods such as extruding the various layers using simultaneous, extrusion, tandum extrusion, or coextrusion. Typically, the hose of the present invention are produced by separate or tandum extrusion for versatility and economic reasons

Having described the invention in detail and by reference to preferred embodiments thereof, it will be apparent to those skilled in the art that modifications and variations are possible without departing from the scope of the invention defined in the appended claims.

What is claimed is:

1. A fuel feed or fuel vapor line hose having reduced fuel permeation hose construction, wherein said tubular structure comprises a conductive, FKM fluoropolymer inner layer having an inner surface and an outer surface and a chlorinated polyethylene backing layer around said fluoropolymer inner layer.

2. The hose of claim 1 wherein said fluoropolymer inner layer is a tetrafluoroethylene-hexafluoropropylene-vinylidene fluoride terpolymer.

3. The hose of claim 1 wherein said hose further comprises an adhesive layer between said fluoropolymer inner layer and said chlorinated polyethylene backing layer.

4. The hose of claim 3 wherein said adhesive layer is a polyamine adhesive layer.

5. The hose of claim 4 wherein said polyamine adhesive layer is a polyallylamine adhesive layer.

6. The hose of claim 1 further comprising:
a reinforcement member on said chlorinated polyethylene backing layer; and
a cover on said reinforcement member.

7. The hose of claim 6 wherein said reinforcement member is a synthetic or natural fiber selected from the group glass fibers, cotton fibers, rayon fibers, polyester fibers, polyamide fibers, and polyamide fibers.

8. The hose of claim 6 wherein said cover layer is a synthetic elastomer selected from the group consisting of styrene-butadiene rubber, butadiene-nitrile rubber, chloroprene rubber, chlorinated polyethylene, chlorosulfonated polyethylene, epichlorohydrin, polyvinyl chloride, ethylene-propylene rubber, ethylene-propylene-diene terpolymer, ultra high molecular weight polyethylene, high density polyethylene and blends thereof.

9. The hose of claim 1 wherein said conductive fluoropolymer inner layer contains a conductive agent selected from the group consisting of carbon, copper, silver, gold, nickel, alloys of such metals, and mixtures thereof.

10. The hose of claim 9 wherein said conductive agent is carbon.

11. A fuel feed hose or a fuel vapor line hose having reduced fuel permeation, said hose comprising an inner layer of an FKM fluoropolymer, a polyamine adhesive layer surrounding said fluoropolymer inner layer, a chlorinated polyethylene backing layer surrounding said adhesive layer, a reinforcement layer surrounding said chlorinated polyethylene layer, and a cover surrounding said reinforcement layer and forming an outer cover layer around said tubular structure.

12. A method of manufacturing a fuel feed or fuel vapor line hose, said method comprising:
forming a first layer of a conductive FKM fluoropolymer; and
forming a chlorinated polyethylene backing layer around said conductive FKM fluoropolymer.

13. The method of claim 12 further comprising:
applying a layer of an adhesive between said conductive FKM fluoropolymer and said chlorinated polyethylene backing layer.

14. The method of claim 13, wherein said adhesive layer is a polyamine adhesive layer.

15. The method of claim 14, wherein said polyamine adhesive layer is a polyallylamine adhesive layer.

16. The method of claim 12 further comprising the steps of:
forming a reinforcement member on said chlorinated polyethylene backing layer; and
forming a cover on said reinforcement member.

17. The method of claim 16 wherein said reinforcement layer comprises synthetic or natural fibers selected from the group consisting of glass fibers, cotton fibers, rayon fibers, polyester fibers, polyamide fibers, and polyamide fibers.

18. The method of claim 16 wherein said cover layer is a synthetic elastomer selected from the group consisting of styrene-butadiene rubber, butadiene-nitrile rubber, chloroprene rubber, chlorinated polyethylene, chlorosulfonated polyethylene, epichlorohydrin, polyvinyl chloride, ethylene-propylene rubber, ethylene-propylene-diene terpolymer, ultra high molecular weight polyethylene, high density polyethylene and blends thereof.

19. The method of claim 12 wherein said conductive fluoropolymer inner layer contains a conductive agent selected from the group consisting of carbon, copper, silver, gold, nickel, alloys of such metals, and mixtures thereof.

20. The hose of claim 19 wherein said conductive agent is carbon.
